(19) United States
(12) Patent Application Publication
(10) Pub. No.: US 2026/0238347 A1
(43) Pub. Date: Aug. 13, 2026

(54) OPTICAL CIRCUIT CONFIGURATIONS TO ENABLE BIDIRECTIONAL OPTICAL PORTS

(71) Applicant: InfiniLink Inc., New Cairo (EG)

(72) Inventors: Salah A. Ibrahim, Cairo (EG); Ramy Awad, New Cairo (EG); Botros George Iskandar Shenouda, Cairo (EG); Ahmed Aboul-Ella, Cairo (EG)

(21) Appl. No.: 19/050,875

(22) Filed: Feb. 11, 2025

(51) Int. Cl. H04B 10/40; H04B 10/532; H04B 10/61; H04J 14/06

(52) U.S. Cl. CPC H04B 10/40; H04B 10/532; H04B 10/614; H04J 14/06

(57) ABSTRACT

The techniques described herein relate to systems, apparatus, articles of manufacture, and methods for optical circuit configurations to enable bidirectional optical ports. An example optical transceiver includes a modulator configured to output a first modulated optical signal by modulating a first optical signal from a laser source, a polarization rotator configured to output a second modulated optical signal by changing a first polarization state of the first modulated optical signal to a second polarization state, and a polarization splitter comprising a bidirectional port, the polarization splitter configured to receive, by the bidirectional port, the first optical signal for output to the modulator, and output, from the bidirectional port, the second modulated optical signal.

### FIELD

The techniques described herein relate generally to optical circuits and, more particularly, to optical circuit configurations to enable bidirectional optical ports.

### BACKGROUND

Data center networking demands are substantially increasing, driven by technologies such as fifth generation cellular (i.e., 5G), artificial intelligence and machine learning (AI/ML), cloud storage, Internet-of-Things (IoT), and video conferencing. Such technologies use high-bandwidth data links, which may include 100 gigabit/second (Gb/s) or greater capabilities over distances ranging from meters to kilometers.

Optical links may be used to implement these high-bandwidth data links by using optical transceivers to transmit and receive light. The optical transceivers may transmit light through an optical medium, such as optical fibers, to other optical transceivers. The optical transceivers may detect and convert received light into an electrical signal for subsequent data communication processing by a host.

### SUMMARY

In accordance with the disclosed subject matter, apparatus, systems, and methods are provided for optical circuit configurations to enable bidirectional optical ports.

Some embodiments relate to an example optical transceiver. The optical transceiver includes a modulator configured to output a first modulated optical signal by modulating a first optical signal from a laser source, a polarization rotator configured to output a second modulated optical signal by changing a first polarization state of the first modulated optical signal to a second polarization state, and a polarization splitter comprising a bidirectional port, the polarization splitter configured to receive, by the bidirectional port, the first optical signal for output to the modulator, and output, from the bidirectional port, the second modulated optical signal.

Some embodiments relate to an apparatus comprising an optical transceiver comprising a first port configured as an optical transmit lane, and a fanout assembly comprising a bidirectional port coupled to the first port of the optical transceiver, the bidirectional port configured to at least one of (i) output an optical signal from a laser source to the first port or (ii) receive a modulated optical signal from the first port.

Some embodiments relate to a system comprising at least one laser source array comprising a plurality of laser sources, at least one optical transceiver configured to convert optical signals from the plurality of laser sources into electrical signals as output to a host, and at least one fanout assembly coupled to the at least one laser source array and the at least one optical transceiver, the at least one fanout assembly comprising at least one bidirectional port configured to at least one of (i) output one of the optical signals to the at least one optical transceiver or (ii) receive a modulated optical signal from the at least one optical transceiver.

The foregoing summary is not intended to be limiting. Moreover, various aspects of the present disclosure may be implemented alone or in combination with other aspects.

### BRIEF DESCRIPTION OF FIGURES

Various aspects and embodiments of the present technology will be described with reference to the following figures. In the figures, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 is an illustration of an example computer rack including a host and an optical transceiver to effectuate optical communication, in accordance with some embodiments of the technology described herein.

FIG. 2A is a schematic illustration of an example implementation of an optical transceiver, in accordance with some embodiments of the technology described herein.

FIG. 2B is a schematic illustration of an example implementation of the optical transceiver of FIG. 2A, in accordance with some embodiments of the technology described herein.

FIG. 2C is a schematic illustration of an example implementation of the optical circulator of FIGS. 2A and/or 2B, in accordance with some embodiments of the technology described herein.

FIG. 2D is a schematic illustration of an expanded implementation of the optical transceiver of FIGS. 2A, 2B, and/or 2C, in accordance with some embodiments of the technology described herein.

FIG. 3 shows a table of specifications for different example configurations of an optical transceiver, in accordance with some embodiments of the technology described herein.

FIGS. 4A-4B are an illustration of an example communication system including multiple hosts, optical transceivers, and fanout regions, in accordance with some embodiments of the technology described herein.

FIG. 5 is a schematic illustration of an example discrete implementation of a portion of the communication system of FIGS. 4A-4B, in accordance with some embodiments of the technology described herein.

FIG. 6 is a schematic illustration of an example co-packaged implementation of a portion of the communication system of FIGS. 4A-4B, in accordance with some embodiments of the technology described herein.

FIG. 7 is a schematic illustration of an example co-packaged implementation of another portion of the communication system of FIGS. 4A-4B, in accordance with some embodiments of the technology described herein.

FIG. 8 is a schematic illustration of the example co-packaged implementation of FIG. 7 along with example fiber block sockets, in accordance with some embodiments of the technology described herein.

FIG. 9A shows a perspective view, a simulation image, and a cross-section view of an example ion-exchange glass-silicon-waveguide stack, in accordance with some embodiments of the technology described herein.

FIG. 9B is a graph representing analysis of a taper width design optimized for low loss, short length coupler, in accordance with some embodiments of the technology described herein.

FIG. 9C is a graph representing coupling loss dependence on the taper length and adhesive refractive index for a coupler region design, in accordance with some embodiments of the technology described herein.

FIG. 10 is a graph representing improvements in chip shoreline density, in accordance with some embodiments of the technology described herein.

FIG. 11 is another graph representing improvements in chip shoreline density, in accordance with some embodiments of the technology described herein.

### DETAILED DESCRIPTION

The present disclosure generally provides techniques for enhancing the beachfront optical interconnect density, or the bandwidth density along the edge of an optical input/output (I/O) interface, by configuring at least some optical ports to operate in a bidirectional manner to reduce the required total port count. The techniques include controlling the polarization state of the optical signals at the transmit (TX) and the laser diode (LD) ports to enable a single optical port to be used in a bidirectional way to have both signals (e.g., TX and LD signals) going out and in, respectively. Beneficially, by enabling at least some of the optical ports associated with the TX and LD signals to operate in a bidirectional manner, the beachfront optical interconnect density can be enhanced with a reduced required total port count.

The dispersion encountered by a transmitted signal (e.g., a transmitted optical signal) sets an upper limit on the product of the transmitted data bandwidth (e.g., data rate) and its reach. Even with large progress in the materials used for making electrical traces and printed circuit boards (PCBs), the distance reach of transmitted electrical signals at high data rates (e.g., 100 gigabits per second (Gbps)) is limited to a few tens of millimeters (mm) due to the large insertion loss. The total throughput generated by electrical chips is increasing with time and owing to the limited increase in the chips perimeter, the throughput increase is coped with by increasing the data rate per transmission lane, which in turn shortens the maximum reach of these lanes. For example, the traditional 2-level modulation format referred to as non-return-to-zero (NRZ) has been replaced by more advanced modulation formats such as 4-level pulse amplitude modulation (PAM4), 8-level pulse amplitude modulation (PAM8), etc., where the data rate per lane is increasing from 100 Gbps to 200 Gbps and even further beyond.

An example manifestation of this technological problem is pushing for a paradigm shift in the subsystems of electrical switching inside Data Center (DC) networks to adopt optical implementations referred to as co-package optics. A traditional top-of-rack (ToR) switch is an application specific integrated circuit (ASIC) switch chip placed inside a box like rack and its input and output ports are connected to the pluggable optical transceivers located at one side of the rack via electrical traces. Electrical repeaters may be used to overcome the high insertion loss of the traces, but this comes with high power consumption, and to avoid that, the optical transceivers are brought close to the switch to form what is typically referred to as co-package optics.

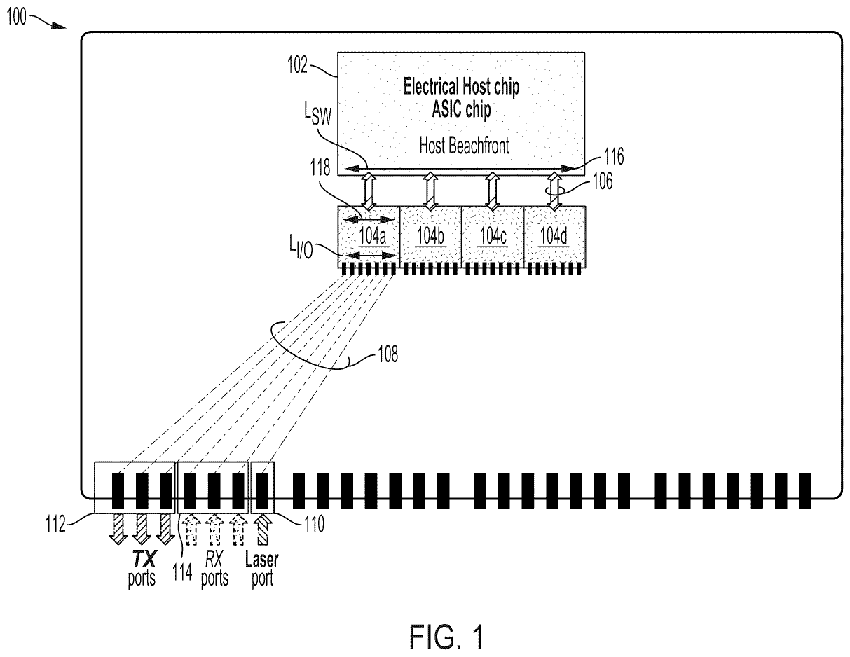

In such a configuration, a set of I/O interfacing units are placed very close to the edge of the electrical chip to convert the electrical signals to and from the switch to the optical domain and vice versa. Each I/O unit will thus have two facets: the first one is just opposite to the electrical switch where very short and efficient electrical traces are used for interconnecting the I/O unit and switch ASIC chip, whereas the second facet is having the optical output ports to which an optical fiber array is attached to get the output from the I/O unit connected to another network node. The first facet is shown in FIG. 1 between the electrical host chip and the optical transceiver. The second facet is shown in FIG. 1 between the optical ports of the optical transceiver and the TX, RX, and laser ports.

The switch ASIC can be connected to the I/O units via high-speed electrical lanes where the electrical signal carried on a lane is used to drive an optical modulator inside the I/O unit in a direct-drive fashion. And with the widespread interest in multi-chip modules, more energy-efficient electrical interconnection methods have been devised such as the Universal Chiplet Interconnect Express (UCIe) protocol, where a large set of low-speed electrical signals are used for interconnection, and the high-speed signal used to drive the modulator at the I/O unit is first regenerated from the low-speed UCIe signals at the I/O unit side. With the advancement in packaging technologies, the data rate of a single UCIe lane has been increasing from one generation to another, and the tradeoffs between speed and cost is expected and observed.

The inventors have recognized the technological problem of increasing demands for bandwidth outpacing the bandwidth capabilities of I/O units due to challenges with I/O unit beachfront density scaling. To illustrate this technological problem, let the length of the switch ASIC's side opposite to the I/O units be Lsw and its transmitted bandwidth (half the switch throughput) be BWsw, then the switch beachfront density is BWsw/Lsw. To ensure the scalability of the I/O interfacing units (e.g., the ability to line up an unlimited incremental count of I/O units along the signaling side of the ASIC switch), the beachfront density of the I/O unit should match that of the switch ASIC or exceed it. By way of example, assume the case where the optical side of each I/O unit possesses 1 port for signal transmission (e.g., the TX port), 1 port for signal reception (e.g., the RX port), and 1 port for delivering the unmodulated laser signal (optical carrier signal) (e.g., the LD port). Furthering the example, allow the length of the I/O unit side that includes these 3 ports be Lvo, and the bandwidth transmitted by the I/O unit via the TX port be BWvo, then the beachfront density of the I/O unit (e.g., BWI/o/Ly/o), should at least be equivalent to BWsw/Lsw.

The inventors have recognized that increasing the beachfront density of the optical I/O unit is mandatory to cope with the continuously increasing ASIC beachfront density. The inventors have recognized that one approach is increasing the pitch density of the optical ports, however this is subject to physical limitations where the spacing between 2 neighboring optical ports is set by the external fiber alignment limits where a center-to-center spacing of 250 micrometers (um) is now a typical value with available optical fiber arrays matching this pitch, and moreover a 127 um-spacing is the state of the art that comes with higher material and labor costs. The inventors have also recognized that another approach involving sharing the same input laser signal among several I/O units enhances the beachfront density but is not highly scalable due to the associated optical losses with signal splitting. Further, the inventors have recognized that if different optical wavelengths are employed, an LD port can be used to carry different wavelengths, and these wavelengths are then shared among the I/O units. This approach increases the beachfront density but demands off-chip wavelength multiplexing circuit which is an overhead to be developed for a large wavelength count and comes with a need for some control and additional power consumption.

The inventors have developed technology that overcomes the technological problems with increasing I/O unit beachfront density by enabling at least some optical ports to operate in a bidirectional manner to reduce the required total port count. The technology involves controlling the polarization state of the signals at the TX ports and the LD ports while allowing RX ports to operate without additional intervention since the incoming signals can have any arbitrary state of polarization. Thus, for example, by setting the polarization of the TX port signal to be the transverse magnetic (TM) polarization and that of the LD port to be transverse electric (TE) polarization, a single optical port can be used in a bidirectional way to have both signals going out and in, respectively.

In some embodiments, outside the I/O unit, an optical circulator can be connected at one side to the shared optical port of the I/O chip. The LD signal incoming to the I/O chip and the modulated signal outcoming from the I/O chip can share the same port but have separate routes through the optical circulator. The LD signal can enter the optical circulator's 1 st port having a TE polarization state and exit the circulator's 2nd port that is connected to the shared I/O optical port.

In some embodiments, inside the I/O unit, a polarization splitter can be used to direct the LD signal towards the optical modulator. As an example, ring-based modulators may be used but other modulator types can be generally used such as Mach-Zehnder or electro-absorption modulators. In some embodiments, the modulated signal has a TE polarization state, like the incoming LD signal, and then an integrated polarization rotating circuit can be used to convert it to the TM polarization state. In some such embodiments, using the same polarization splitter, the modulated signal comes out of the I/O unit to reach the 2nd port of the optical circulator, and then the modulated signal can be directed to the 3rd port that is equipped with the optical fiber that connects this node to some other node in the network.

In some embodiments, the optical splitter and the polarization rotator used at the I/O unit can be realized as a single integrated component such as a polarization splitter-rotator (PSR) device. Alternatively, the optical splitter and the polarization rotator may be implemented as separate integrated components.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

Turning to the figures, the illustrated example of FIG. 1 is an illustration of an example computer rack 100 including a host 102 and at least one optical transceiver 104a to effectuate optical communication. Although four optical transceivers 104a, 104b, 104c, 104d (collectively 104a-d) are shown, the rack 100 may be implemented using fewer or more transceivers.

As shown in this example, the computer rack 100 is a switching rack that may include one or more switches (e.g., network switches). An example of the switch(es) is a Top-of-Rack (ToR) switch. For example, the rack 100 may include and/or implement a ToR switch, and the TOR switch may include and/or implement the host 102 and/or one(s) of the optical transceivers 104a-d.

The host 102 of this example is an electrical host chip implemented as an application specific integrated circuit (ASIC) chip. The host 102 is an I/O unit. Alternatively, the host 102 may be an I/O unit in combination with at least one other unit, such as a processing unit implemented by one more central processing units (CPUs), graphics processing units (GPUs), artificial intelligence and/or machine learning (AI/ML) processors (e.g., neural network processors), digital signal processors (DSPs), field programmable gate arrays (FPGAs), and/or quantum processors. For example, the host 102 may include at least one computer hardware processor configured to execute machine-readable instructions.

The host 102 is shown coupled (e.g., electrically coupled) to the optical transceivers 104a-d through electrical connections 106. Examples of the electrical connections 106 include pads, traces, wires, and vias. For example, the electrical connections 106 of FIG. 1 can be traces (e.g., electrical traces such as copper and/or gold electrical traces).

The optical transceivers 104a-d can transmit and/or receive signals. For example, the optical transceivers 104a-d can receive optical signals, convert the optical signals into electrical signals, and output the electrical signals to the host 102. In another example, the optical transceivers 104a-d can receive electrical signals from the host 102, convert the electrical signals into optical signals, and output the optical signals.

The optical transceivers 104a-d can receive and/or output optical signals using optical connections 108. Examples of the optical connections 108 include optical fibers and optical waveguides. For example, the optical connections 108 can be optical waveguides embedded in, integrated into, included in, and/or packaged into a substrate. Examples of the substrate include ceramic, glass, polymer, epoxy resin reinforced with fiberglass (e.g., FR-4), silicon or silicon compounds, and thin films. For example, the substrate can be implemented by a printed circuit board (PCB). In another example, the substrate can be implemented by glass. In yet another example, the substrate can be implemented by one or more polymers such that the substrate is a polymer-based substrate.

The rack 100 can effectuate optical communication between the host 102 and other host(s) (not shown) in different rack(s) using ports 110, 112, 114. The ports 110, 112, 114 include a first port 110, second ports 112, and third ports 114.

As shown, the second ports 112 and the third ports 114 respectively include three ports configured to be coupled to the optical transceiver 104a. Alternatively, the optical transceiver 104a may be coupled (e.g., connected) to fewer or more ports than shown. The port connections to optical transceivers 104b-d are omitted for enhanced clarity of FIG. 1.

The first port 110 is a laser port configured to receive a laser signal from a laser source (e.g., a laser energy source). The laser signal is an optical signal. The laser source can be a laser diode (LD) such that the first port 110 can be an LD port.

In some embodiments, the laser source can be implemented by a pluggable laser source (e.g., an external laser source (ELS)). The pluggable laser source can be a separate (disaggregated) pluggable module housing continuous wave lasers that can provide optical power over fiber. For example, the pluggable laser source can be plugged into the first port 110 to provide the laser signal to the optical transceiver 104a through the first port 110.

The second ports 112 are transmit (TX) ports. For example, the second ports 112 can be configured to transmit optical signals from the optical transceiver 104a to an external host.

The third ports 114 are receive (RX) ports. For example, the third ports 114 can be configured to receive optical signals from an external host and provide the received optical signals to the optical transceiver 104a.

The inventors have recognized technological challenges with increasing the scalability of a beachfront 116 (identified by Host Beachfront) of the host 102. As shown in FIG. 1, a set of the optical transceivers 104a-d are placed very close to the edge of the host 102 to convert electrical signals received via the electrical connections 106 to and from the host 102 to the optical domain and vice versa. Each optical transceiver 104a-d has two facets: the first one is just opposite to the host 102 where very short and efficient electrical connections 106 are used for interconnecting the optical transceivers 104a-d and the host 102, whereas the second facet is having the optical output ports 114 to which an optical fiber array (e.g., the optical connections 108) is attached to get the output from the optical transceivers 104a-d connected to another network node.

The inventors have recognized the technological problem of increasing demands for bandwidth outpacing the bandwidth capabilities of I/O units due to challenges with beachfront density scaling of I/O units, such as the host 102. To illustrate this technological problem, let the length of the host 102 side opposite to optical transceivers 104a-d be L_{SW} and its transmitted bandwidth (half the switch throughput) be BW_{SW}, then the host 102 density is BW_{SW}/L_{SW}. To ensure the scalability of the optical transceivers 104a-d (e.g., the ability to line up an unlimited incremental count of optical transceivers 104a-d along the signaling side of the host 102), a combination of a beachfront density 118 for each of the optical transceivers 104a-d should match that of the host 102 or exceed it. By way of example, assume the case where the optical side of each optical transceiver 104a-d possesses 1 port for signal transmission (e.g., the TX port), 1 port for signal reception (e.g., the RX port), and 1 port for delivering the unmodulated laser signal (optical carrier signal) (e.g., the LD port).

Furthering the example, allow the length of the optical transceivers 104a-d that includes these 3 ports be L_{I/O}, and the bandwidth transmitted by the optical transceiver 104a-d via the TX port be BW_{I/O}, then the beachfront density of the optical transceivers 104a-d (e.g., BWI_{I/O}/L_{I/O}), should at least be equivalent to BW_{SW}/L_{SW}.

The inventors have recognized that increasing the beachfront density of the optical transceivers 104a-d is mandatory to cope with the continuously increasing host 102 beachfront density 116. As discussed further below, the inventors have developed technology involving bidirectional optical ports that solves the problem of increasing demands for bandwidth outpacing the bandwidth capabilities of I/O units, such as optical transceivers, due to challenges with beachfront density scaling of the I/O units.

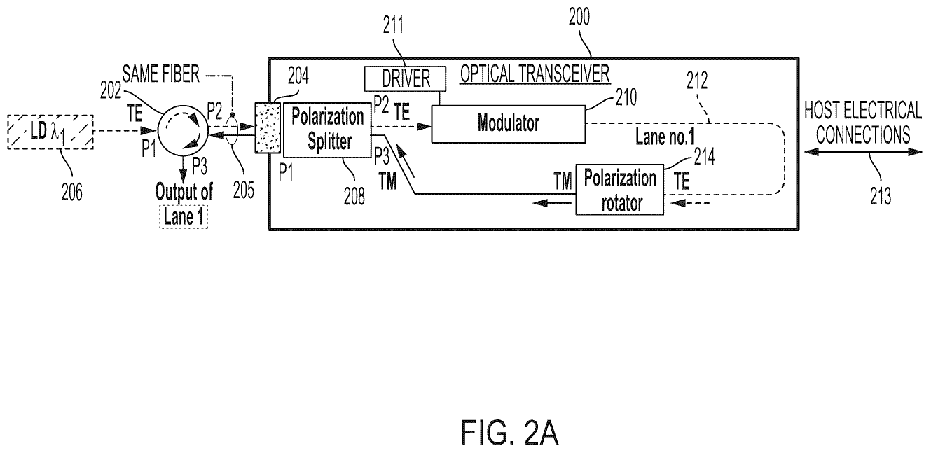

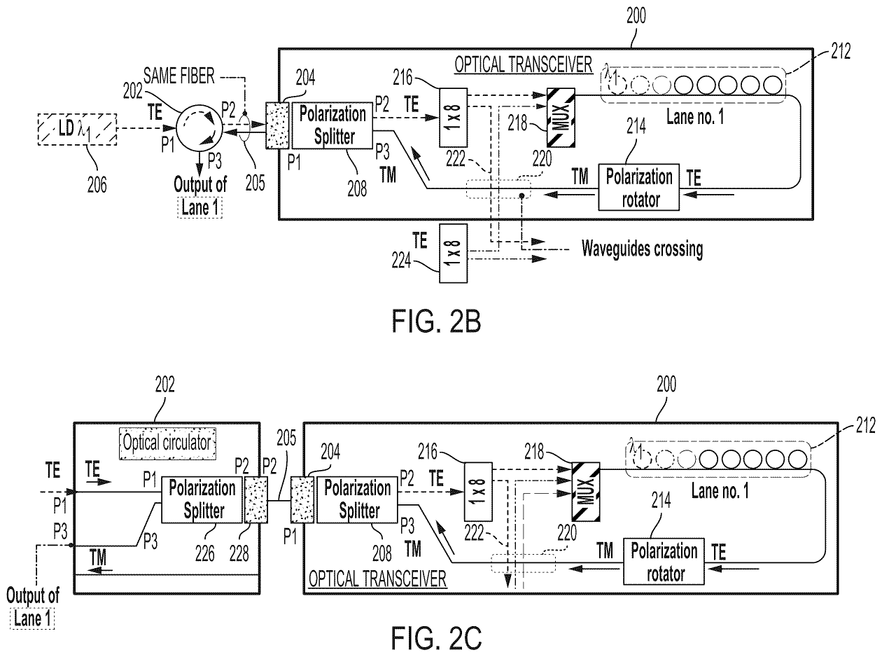

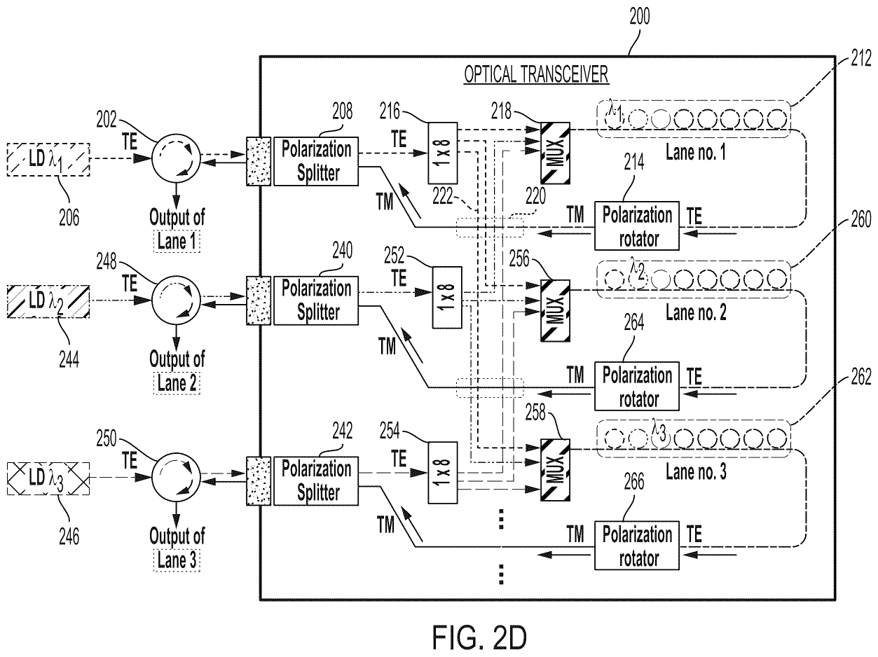

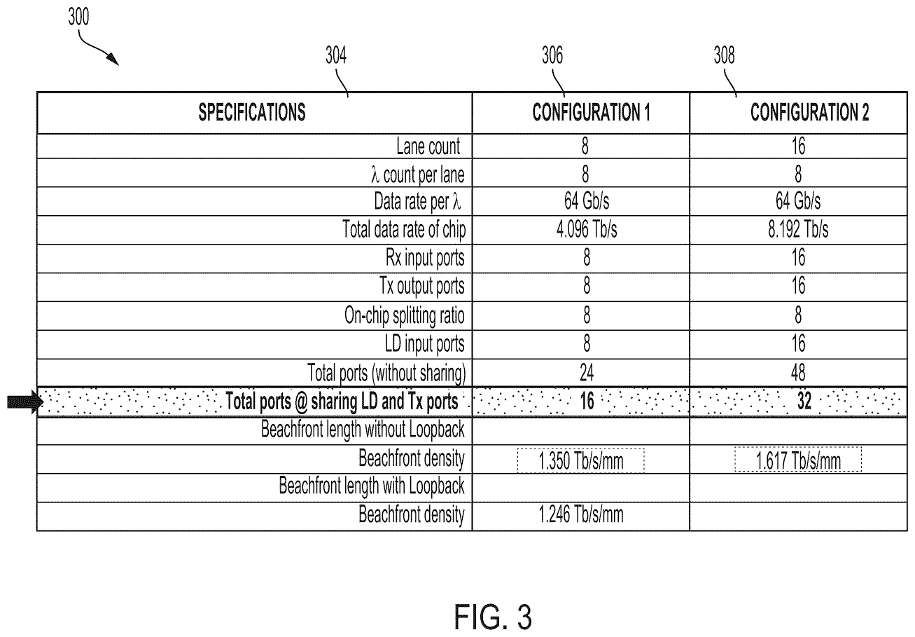

FIG. 2A is a schematic illustration of an example implementation of an optical transceiver 200. In some embodiments, the optical transceiver 200 corresponds to and/or implements one of the optical transceivers 104a-d of FIG. 1. For example, the optical transceiver 104a of FIG. 1 can be implemented at least in part by the optical transceiver 200 shown in FIG. 2A.

The optical transceiver 200 of this example is coupled (e.g., optically coupled) to an optical circulator 202 through a coupler 204. The coupler 204 may be an optical coupler. The optical coupler may be an edge coupler. For example, the coupler 204 can be configured to be coupled to an optical fiber 205, such that the optical circulator 202 is coupled to the coupler 204 via the optical fiber 205.

The optical fiber 205 is shown as two logical connections implemented by the same physical connection. Examples of the optical fiber 205 include a single-mode fiber or a polarization-maintaining fiber.

The optical circulator 202 can be configured to receive an optical signal, such as a laser signal, from a laser source 206. As shown, the laser source 206 is a laser diode (LD) configured to emit laser energy at a particular wavelength (21). The emitted laser energy of this example has a transverse electric (TE) polarization state. In some embodiments, the laser source 206 can be implemented by a pluggable laser source.

The optical circulator 202 can be configured to redirect an optical signal into a different destination. For example, the optical circulator 202 can be a multi-port device configured such that light entering any port exits from the next port. In some embodiments, the optical circulator 202 includes and/or is implemented by at least one of a polarization beam splitting and combining element, a nonreciprocal polarization rotation element, or a beam shifting element.

As shown, the optical circulator 202 is a three port device with a first port (P1), a second port (P2), and a third port (P3). Alternatively, the optical circulator 202 may have a different number of ports.

P2 of the optical circulator 202 can be configured as a bidirectional port. For example, P2 can be configured to transmit and/or output light (to the optical transceiver 200) having a first polarization and receive light (from the optical transceiver 200) having a second polarization that is different from the first polarization. In such an example, the optical circulator 202 can be configured such that light that enters P1 exits P2 and light that enters P2 exits P3. For example, the optical circulator 202 can be configured such that an optical signal from the laser source 206 that enters P1 exits P2. Furthering the example, the optical circulator 202 can be configured such that an optical signal from the optical transceiver 200 that enters P2 exits P3, which is shown as an output of Lane 1. The output of Lane 1 can correspond to one of the second ports 112 of FIG. 1, such that the output of Lane 1 is a TX lane.

The optical transceiver 200 includes a polarization splitter 208 configured to direct an incoming light beam to a particular output port based on its polarization state. For example, the polarization splitter 208 can be configured to split incoming light into TE polarized beams and TM polarized beams. The polarization splitter 208 may also be referred to as an optical splitter.

The polarization splitter 208 of this example is a three port device with a first port (P1), a second port (P2), and a third port (P3). Alternatively, the polarization splitter 208 may have a different number of ports.

P1 of the polarization splitter 208 can be configured as a bidirectional port. For example, P1 can be configured to receive light having a first polarization and output and/or transmit light having a second polarization that is different from the first polarization. In such an example, the polarization splitter 208 can be configured such that light that enters P1 with the TE polarization state exits P2 and light that enters P3 with the TM polarization state exits P1 The polarization splitter 208 is shown as outputting the optical signal from the laser source 206 via the optical circulator 202 to a modulator 210. Examples of the modulator 210 include a ring-based modulator, a Mach-Zehnder modulator, and an electro-absorption modulator.

The optical transceiver 200 includes the modulator 210 to modulate the optical signal to generate a modulated optical signal. The modulated optical signal may implement a first lane 212 (identified by Lane No. 1). The first lane 212 can be a TX lane.

In some embodiments, the modulator 210 can be an optical modulator configured to adjust, change, and/or otherwise manipulate a property of light. In some such embodiments, the modulator 210 can change at least one of an amplitude, a data rate, a phase, or a modulation constellation of an incoming optical signal.

In some embodiments, the optical transceiver 200 includes a driver 211 (shown) to control and/or cause the modulator 210 to change the incoming optical signal. The driver 211 may be a re-configurable driver. For example, the driver 211 can change the modulation format of the optical signal received by the modulator 210 such that at least one of an amplitude, a data rate, a phase, or a modulation constellation of the incoming signal is changed.

As shown, the driver 211 is separate from the modulator 210. For example, the driver 211 and the modulator 210 may be separate, discrete components. Alternatively, the driver 211 and the modulator may be integrated into a monolithic component.

Additionally and/or alternatively, the optical transceiver 200 may include circuitry used to change the format of the electrical driving signal incoming to the optical transceiver 200, via the host electrical connections 213, from a first format (e.g., UCIe format) to a second, different format (e.g., PAM4 format). Examples of the circuitry include a gearbox, a forward error correction (FEC) encoder, and an FEC decoder.

As shown, the modulator 210 can modulate an optical signal having the TE polarization to output a modulated optical signal having the TE polarization. The modulator 210 can receive the optical signal from the polarization splitter 208 and output the modulated optical signal to a polarization rotator 214.

In some embodiments, the polarization splitter 208 and the polarization rotator 214 are implemented as a single integrated component. The single integrated component may be a polarization splitter-rotator (PSR) device. Alternatively, the polarization splitter 208 and the polarization rotator 214 may be implemented as separate components.

The optical transceiver 200 includes the polarization rotator 214 to convert and/or rotate the polarization axis of a linearly polarized light beam by a desired and/or designed angle. For example, the polarization rotator 214 can be an optical device that rotates the polarization of an incoming optical signal by a fixed angle. In such an example, the polarization rotator 214 can be an optical device that converts a polarization state of an incoming optical signal to a different polarization state.

As shown, the polarization rotator 214 can be configured to rotate an optical signal having a first polarization state to a second polarization state. The optical signal of this example is the modulated optical signal that is output from the modulator 210. The first polarization state of this example is the TE polarization state and the second polarizations state of this example is the TM polarization state.

The polarization rotator 214 can be configured to output a rotated, modulated optical signal to P3 of the polarization splitter 208. The polarization splitter 208 can be configured to direct the optical signal having the TM polarization state to P1 of the polarization splitter 208. The polarization splitter 208 can be configured to output the optical signal having the TM polarization state to P2 of the optical circulator 202 which, in turn, can direct the optical signal having the TM polarization state to P3 of the optical circulator 202. The optical circulator 202 can output the optical signal having the TM polarization state for transmission to a host, such as by outputting the optical signal to one of the second ports 112 of FIG. 1.

Beneficially, the optical transceiver 200 can be configured to enhance the I/O beachfront density by enabling an optical port to operate in a bidirectional manner to reduce the required total port count. For example, the optical transceiver 200 can be configured as shown in FIG. 2A such that the coupler 204 can both receive an optical signal from the laser source 206 (e.g., an LD signal) and output a modulated optical signal (e.g., a TX signal) through the same optical pathway. The optical transceiver 200 achieves such bidirectionality by controlling the polarization state of the incoming laser signals from the laser source 206 and the outgoing TX signals from the optical transceiver 200. Thus, for example, by setting the polarization of the TX port signal (e.g., the rotated, modulated optical signal from the polarization rotator 214) to be TM and that of the laser source 206 to be TE, a single optical port can be used in a bidirectional way to have both signals going out and in, respectively, as shown in FIG. 2A.

As shown, outside the optical transceiver 200, the optical circulator 202 is connected at one side to the shared optical port of the optical transceiver 200. The laser signal incoming to the optical transceiver 200 and the modulated signal outcoming from the optical transceiver 200 share the same port but have separate routes through the optical circulator 202.

FIG. 2B is a schematic illustration of another example implementation of the optical transceiver 200 of FIG. 2A, which implements the first lane 212 using multiple wavelengths. As shown, the modulator 210 of FIG. 2A (not shown for clarity) can implement the first lane 212 using at least a first wavelength λ₁ of the laser signal from the laser source 206.

As shown, the optical transceiver 200 can include a first power splitter 216, a first multiplexer 218, and a waveguides crossing 220 for a plurality of waveguides 222. The first power splitter 216 of this example is 1×8 optical power splitter configured with 1 input and 8 outputs with an even split ratio across all outputs. Alternatively, the first power splitter 216 may not have an even split ratio across all outputs. Alternatively, the first power splitter 216 may have a different configuration, such as a 1×2, 1×4, or 1×16 configuration.

In some embodiments, the number of lanes for a particular configuration (e.g., 2 lanes in a 1×2 configuration, 4 lanes in a 1×4 configuration, etc.) is based on the maximum number of splits the incoming LD signal from the laser source 206 can encounter inside the optical transceiver 200. For example, further splitting of the incoming LD signal reduces the optical power going to each lane, and the optical power after all splitting should meet and/or exceed a desired power level that allows the proper operation of each lane (e.g., by matching a target power budget). In such an example, for a given LD power input to the optical transceiver 200, the maximum count of optical power splits may be limited to a given number (e.g., 2, 4, 8, 16, etc.) irrespective of the lane count, and thus a 16-lane implementation may need twice the number of LD ports compared to an 8-lane implementation for the same input LD power.

The first multiplexer 218 can be configured to select one of a plurality of inputs for output. For example, the first multiplexer 218 can be controlled to select a first input for output, where the first input is the output from the first power splitter 216. Furthering the example, the first multiplexer 218 can be controlled to select a second input for output, where the second input is the output from a second power splitter 224 associated with a different laser source having a different wavelength.

FIG. 2C is a schematic illustration of an example implementation of the optical circulator 202 of FIGS. 2A and/or 2B. Also shown is the optical transceiver 200 of FIGS. 2A and/or 2B.

As shown, the optical circulator 202 is implemented by a polarization splitter 226. In some embodiments, the polarization splitter 208 and the polarization splitter 226 are the same type of polarization splitter. Alternatively, they may be different.

As shown, P1, P2, and P3 of the optical circulator 202 corresponds to P1, P2, and P3 of the polarization splitter 226, respectively. The optical circulator 202 of this example is coupled to another coupler 228. The coupler 228 may be an optical coupler. The optical coupler may be an edge coupler. For example, the coupler 228 can be configured to be coupled to the optical fiber 205. The optical fiber 205 is shown as two logical connections implemented by the same physical connection between the couplers 204, 228.

FIG. 2D is a schematic illustration of an expanded implementation of the optical transceiver 200 of FIGS. 2A, 2B, and/or 2C. For example, the optical transceiver 200 of FIG. 2D includes the polarization splitter 208, the first power splitter 216, the first multiplexer 218, the first lane 212, the polarization rotator 214, the waveguides crossing 220, and the plurality of waveguides 222 of FIGS. 2A, 2B, and/or 2C. Also shown, is the laser source 206 of FIGS. 2A and/or 2B. Some reference numerals shown in FIGS. 2A, 2B, and/or 2C are not shown in FIG. 2D for enhanced clarity of the figure.

In the illustrated example of FIG. 2D, the optical transceiver 200 includes polarization splitters 240, 242 to receive optical signals from respective laser sources 244, 246 via optical circulators 248, 250. The polarization splitters 240, 242 output optical signals having the TE polarization state to power splitters 252, 254. Outputs from the power splitters 252, 254 are provided to multiplexers 256, 258. Outputs from the multiplexers 256, 258 are modulated by modulators (not shown) to generate respective lanes 260, 262. Outputs from the modulators are provided to polarization rotators 264, 266 to rotate the TE polarization state of the modulated signal outputs to the TM polarization state.

As shown, outputs from the polarization rotators 266, 268 are provided to ports of the polarization splitters 240, 242. The polarization splitters 240, 242 provide the modulated signal outputs having the TM polarization state to the optical circulators 248, 250 which, in turn, output them as lane outputs (identified by Output of Lane 2, Output of Lane 3, etc.).

As shown, the optical signals from the laser sources 206, 244, 246 are split by the power splitters 216, 252, 254 such that the optical signals are provided to each of the multiplexers 218, 256, 258 for modulation into the respective lanes 212, 260, 262.

Beneficially, the implementation of the optical transceiver 200 shown in FIG. 2D can be used to establish TX lanes 212, 260, 262 using a plurality of different wavelengths.

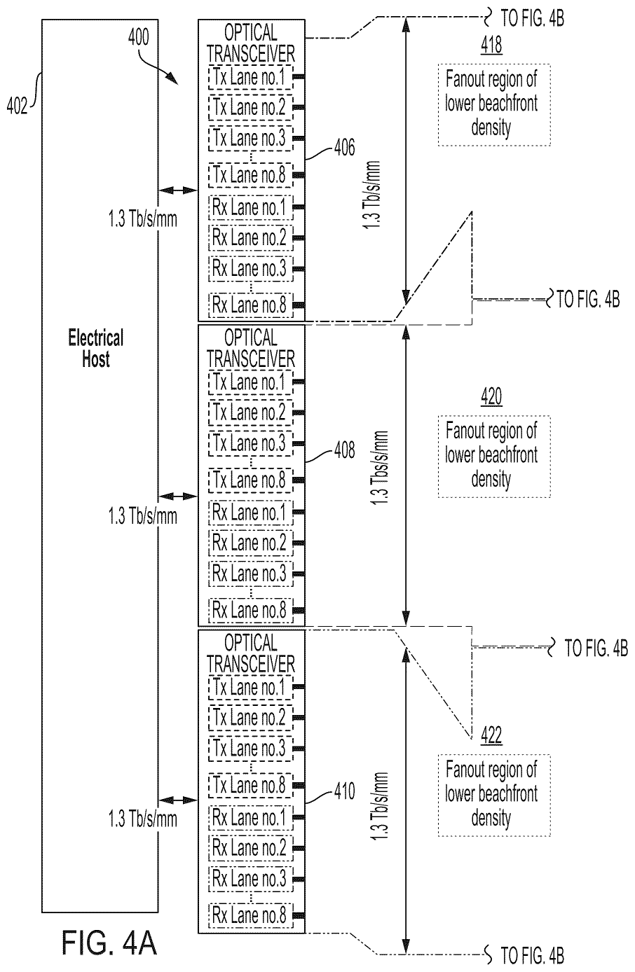

FIG. 3 shows a table 300 of specifications 302 for different example configurations 304, 306 of an optical transceiver, such as one(s) of the optical transceivers 104a-d of FIG. 1 and/or the optical transceiver 200 of FIGS. 2A, 2B, 2C, and/or 2D. As shown, a first configuration 306 can correspond to the optical transceiver 200 of FIGS. 2A, 2B, 2C, and/or 2D corresponds to an optical transceiver having 8 lanes. A second configuration 308 can correspond to an optical transceiver having 16 lanes, such as the optical transceiver 200 being expanded from the 3 shown lanes in FIG. 2D to at least 16 lanes.

The configurations 306, 308 shown assume that each optical lane comprises 8 wavelengths and the optical power from each LD port is split by 8. In some embodiments, to facilitate the process of aligning optical fibers to the optical transceiver, 2 extra optical waveguides are placed at the opposite edges of the optical transceivers and connected to each other to form an optical loop, and thus the quality of the fiber array alignment to the chip is directly examined by maximizing the power going through these edge waveguides. The table 300 shows the results in case of having such loopback or not.

Beneficially, by enabling at least some optical ports to operate in a bidirectional manner, the total number of ports required to achieve a particular total data rate (e.g., 4.096 terabits per second (Tb/s) can be reduced. In the first configuration 306, the total number of ports required to achieve a total data rate of 4.096 Tb/s is 24 ports (8 RX, 8 TX, and 8 LD ports), which can be reduced to 16 total ports by combing the TX and LD ports using bidirectional ports. In the second configuration 308, the total number of ports required to achieve a total data rate of 8.192 Tb/s is 48 ports (16 RX, 16 TX, and 16 LD ports), which can be reduced to 32 total ports by combing the TX and LD ports using bidirectional ports.

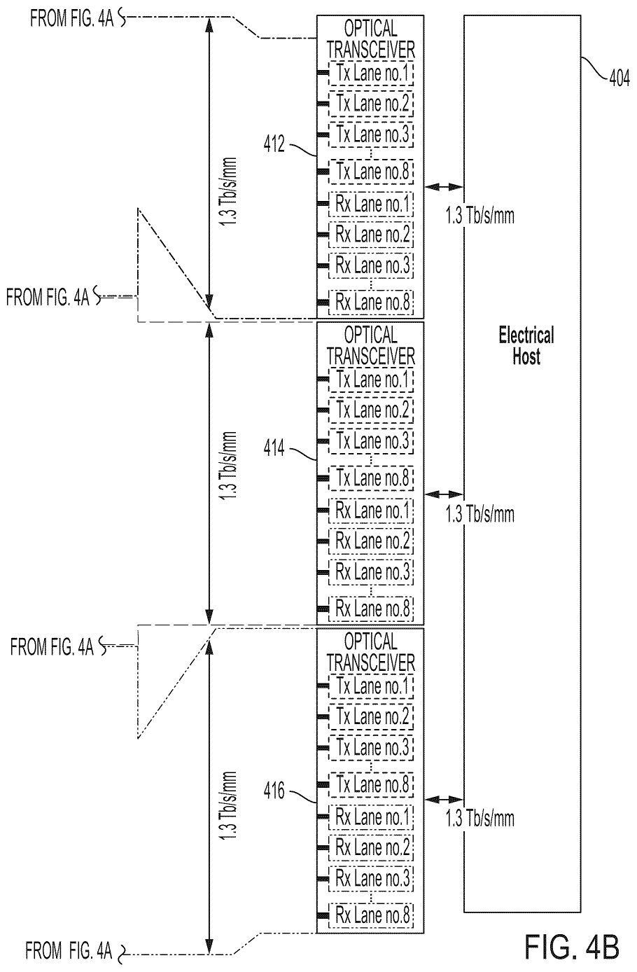

FIGS. 4A-4B are an illustration of an example communication system 400 including multiple hosts 402, 404, optical transceivers 406, 408, 410, 412, 414, 416, and fanout regions 418, 420, 422. In some embodiments, the communication system 400 can be configured to implement a 12 Tb/s solution with all planar fibers or package waveguides.

In some embodiments, the hosts 402, 404 can correspond to and/or implement the host 102 of FIG. 1. For example, a first host 402 of the hosts 402, 404 can correspond to and/or implement the host 102 of FIG. 1. Furthering the example, a second host 404 of the hosts 402, 404 can correspond to and/or implement the host 102 of FIG. 1 or a different host such that the host 102 can communicate with the second host 404 via at least one optical transceiver.

In some embodiments, the optical transceivers 406, 408, 410, 412, 414, 416 can correspond to and/or implement the optical transceivers 104a-d of FIG. 1 and/or the optical transceiver 200 of FIGS. 2A, 2B, 2C, and/or 2D. For example, a first optical transceiver 406 of the optical transceivers 406, 408, 410, 412, 414, 416 can correspond to and/or implement the optical transceiver 104a of FIG. 1 and/or the optical transceiver 200 of FIGS. 2A, 2B, 2C, and/or 2D.

As shown, each of the optical transceivers 406, 408, 410, 412, 414, 416 are configured in accordance with the first configuration 306 of FIG. 3. Alternatively, one(s) of the optical transceivers 406, 408, 410, 412, 414, 416 may be configured in accordance with a different configuration, such as the second configuration 308 of FIG. 3.

The fanout regions 418, 420, 422 represent regions of lower beachfront density. For example, the number of optical links in the fanout regions 418, 420, 422 may be greater than the number of optical links between the hosts 402, 404 and their corresponding optical transceivers 406, 408, 410, 412, 414, 416.

In some embodiments, the fanout regions 418, 420, 422 are implemented by fanout assemblies. The fanout assemblies may be implemented by a combination of electrical and/or optical components to enable bidirectional port functionality associated with optical signals that pass through TX and LD ports.

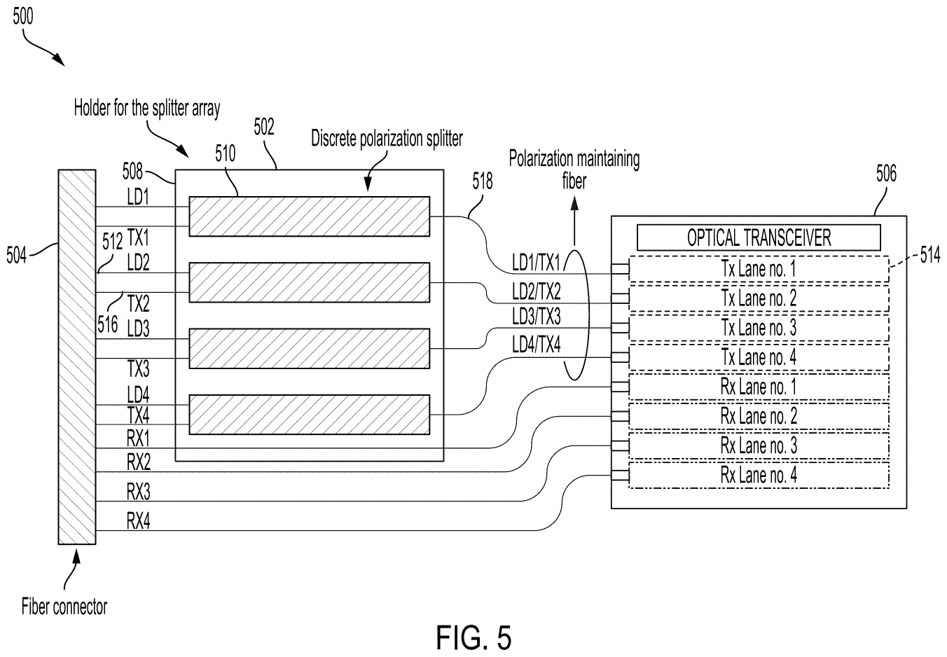

FIG. 5 is a schematic illustration of a portion 500 of a communication system including an example implementation of a fanout assembly 502 to enable bidirectional port functionality. Also shown, is a fiber connector 504 and an optical transceiver 506.

In some embodiments, the communication system portion 500 can be a portion of the communication system 400 of FIGS. 4A-4B. For example, the optical transceiver 506 can correspond to the optical transceiver 406 and the fanout assembly 502 can correspond to the fanout region 418.

The fanout assembly 502 of this example includes a holder 508 and a plurality of polarization splitters 510. The holder 508 is a holder for the array of the polarization splitters 510. The holder 508 can be configured to secure the polarization splitters 510 in place and/or to maintain a desired spacing between one(s) of the polarization splitters 510.

As shown, each of the polarization splitters 510 are discrete (e.g., separate) components. In some embodiments, each of the polarization splitters 510 can correspond to and/or be implemented by the polarization splitter 208 of FIGS. 2A, 2B, 2C, and/or 2D and/or the polarization splitters 240, 242 of FIG. 2D. In some embodiments, each of the polarization splitters 510 can correspond to and/or be implemented by the polarization splitter 226 of FIG. 2C.

As shown, optical signals 512 (e.g., laser signals) (identified by LD1, LD2, LD3, LD4) from laser sources (e.g., laser diodes) (not shown) are input to a respective one of the polarization splitters 510. The polarization splitters 510 direct the optical signals 512, based on their polarization state, to a corresponding lane 514 of the optical transceiver 506.

The optical transceiver 506 can modulate and rotate the incoming optical signals 512 to generate modulated optical signals (e.g., rotated, modulated optical signals). The optical transceiver 506 can output the modulated optical signals to a corresponding one of the polarization splitters 510 of the fanout assembly 502. The polarization splitters 510 can direct the modulated optical signals to a corresponding TX lane 516 (identified by TX1, TX2, TX3, TX4).

Beneficially, the fanout assembly 502 and/or the optical transceiver 506 can be configured to control the polarization state of the optical signals 512 from the laser sources and the polarization state of the modulated optical signals output from the optical transceiver 506 to enable bidirectional operation of the optical connections 518 between the fanout assembly 502 and the optical transceiver 506. For example, a first optical connection (identified by LD1/TX1) of the optical connections 518 can be used to provide optical signal LD1 from the fanout assembly 502 to the optical transceiver 506 at a first time and provide a modulated optical signal TX1 from the optical transceiver 506 to the fanout assembly 502 at a second time after the first time and over the same optical connection 518.

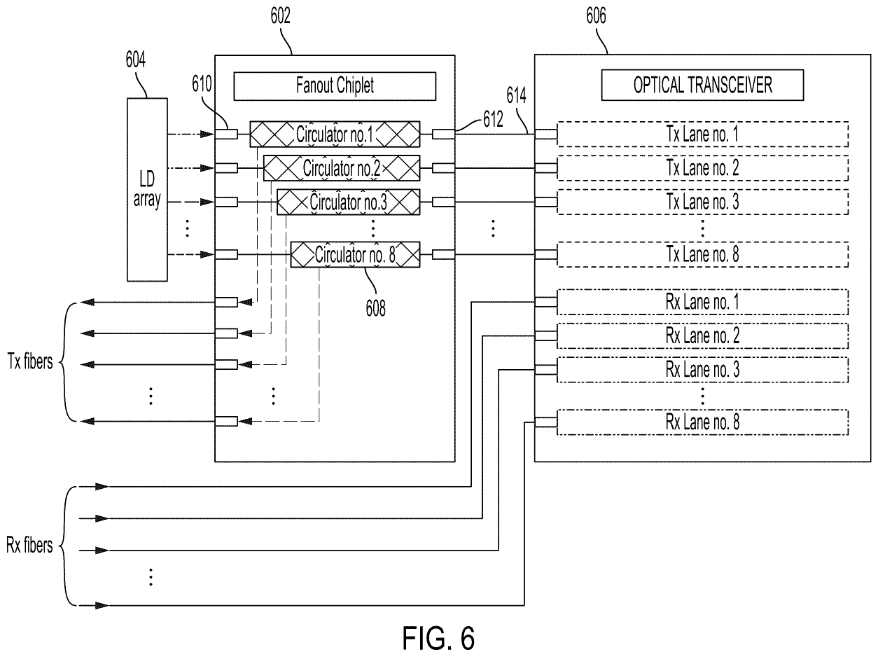

FIG. 6 is a schematic illustration of a portion 600 of a communication system including an example implementation of a fanout assembly 602 to enable bidirectional port functionality. Also shown, is a laser source array 604 and an optical transceiver 606.

In some embodiments, the communication system portion 600 is a co-packaged implementation. For example, the fanout assembly 602 and the optical transceiver 606 can be co-packaged on the same substrate. In such an example, the fanout assembly 602 and the optical transceiver 606 can be co-packaged on the same PCB or glass substrate.

In some embodiments, the communication system portion 600 can be a portion of the communication system 400 of FIGS. 4A-4B. For example, the optical transceiver 606 can correspond to the optical transceiver 406 and the fanout assembly 602 can correspond to the fanout region 418.

The laser source array 604 of this example is a laser diode array (identified by LD Array). For example, the laser source array 604 can include a plurality of laser diode sources. In some embodiments, each the plurality of laser diode sources can be configured to emit and/or output a laser signal having a different wavelength. Alternatively, one(s) of the laser diode sources may be configured to emit and/or output a laser signal having the same wavelength.

The fanout assembly 602 of this example is a fanout chiplet, which is implemented by a plurality of optical circulators 608. For example, each of the optical circulators 608 can be implemented by the optical circulator 202 of FIGS. 2A, 2B, 2C, and/or 2D and/or the optical circulators 248, 250 of FIG. 2D.

The fanout assembly 602 includes first couplers 610 on a first side of the fanout assembly 602 and second couplers 612 on a second side of the fanout assembly 602.

As shown, a first number of the first couplers 610 is greater than a second number of the second couplers 612. For example, the plurality of optical circulators 608 can be configured to enable outputs from the fanout assembly 602 to the optical transceiver 606 to have bidirectional functionality. In such an example, the plurality of optical circulators 608 can be configured to (i) provide optical signals from the laser source array 604 to the optical transceiver 606 through optical connections 614 and (ii) provide modulated optical signals from the optical transceiver 606 to the fanout assembly 602 through the same optical connections 614.

The providing of the optical signals and the modulated optical signals through the optical connections 614 are provided at different times. In some embodiments, the providing at different times is controlled by the fanout assembly 602, the optical transceiver 606, and/or at least one controller (not shown). The at least one controller can be in communication with at least one of the fanout assembly 602 or the optical transceiver 606.

Examples of the bus include an Inter-Integrated Circuit (I2C) bus and a Serial Peripheral Interface (SPI) bus.

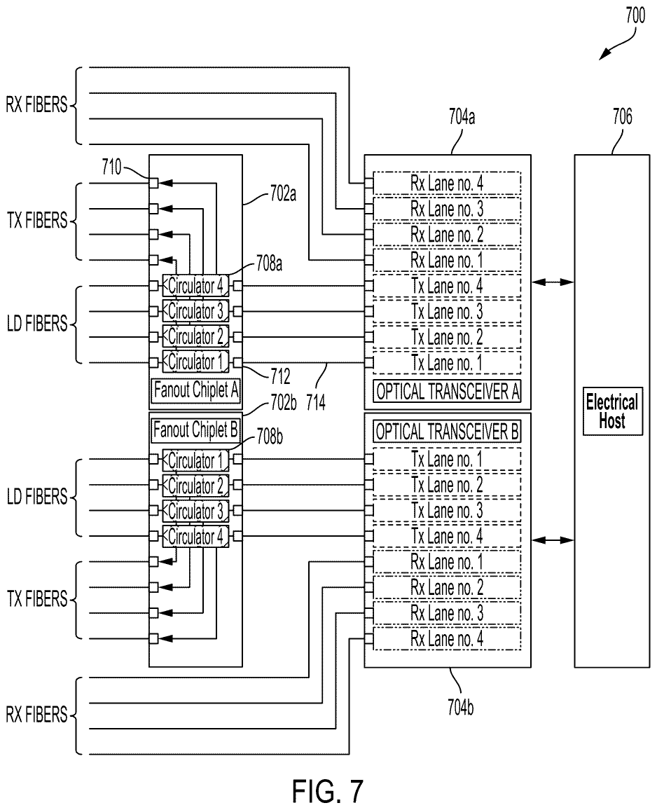

FIG. 7 is a schematic illustration of a portion 700 of a communication system including an example implementation of fanout assemblies 702a, 702b to enable bidirectional port functionality. Also shown, are optical transceivers 704a, 704b and a host 706. In some embodiments, the host 706 can correspond to and/or be implemented by the host 102 of FIG. 1.

The communication system portion 700 shown implements 4 RX and 4 TX lanes. Alternatively, the communication system portion 700 may be expanded to implement 8 RX and 8 TX lanes, 16 RX and 16 TX lanes, 32 RX and 32 TX lanes, and so on.

In some embodiments, the communication system portion 700 is a co-packaged implementation. For example, the fanout assemblies 702a, 702b and the optical transceivers 704a, 704b can be co-packaged on the same substrate. In such an example, the fanout assemblies 702a, 702b, the optical transceivers 704a, 704b, and the host 706 can be co-packaged on the same PCB or glass substrate. Alternatively, the host 706 may be separately packaged from the co-packaging of the fanout assemblies 702a, 702b and the optical transceivers 704a, 704b.

The fanout assemblies 702a, 702b of this example are fanout chiplets, which are respectively implemented by a plurality of optical circulators 708a, 708b. For example, each of the optical circulators 708a, 708b can be implemented by the optical circulator 202 of FIGS. 2A, 2B, 2C, and/or 2D and/or the optical circulators 248, 250 of FIG. 2D.

A first fanout assembly 702a of the fanout assemblies 702a, 702b includes first couplers 710 on a first side of the first fanout assembly 702a and second couplers 712 on a second side of the first fanout assembly 702a. As shown, a first number of the first couplers 710 is greater than a second number of the second couplers 712. For example, the plurality of optical circulators 708a can be configured to enable outputs from the first fanout assembly 702a to a first optical transceiver 704a of the optical transceivers 704a, 704b to have bidirectional functionality. In such an example, the plurality of optical circulators 708a can be configured to (i) provide optical signals from laser sources (e.g., laser diode outputs carried by laser diode (LD) fibers) to the first optical transceiver 704a through optical connections 714 and (ii) provide modulated optical signals from the first optical transceiver 704a to the first fanout assembly 702a through the same optical connections 714.

The providing of the optical signals and the modulated optical signals through the optical connections 714 are provided at different times. In some embodiments, the providing at different times is controlled by the first fanout assembly 702a, the first optical transceiver 704a, and/or at least one controller (not shown). The at least one controller can be in communication with at least one of the first fanout assembly 702a or the first optical transceiver 704a via a bus. Examples of the bus include an I2C bus and a SPI bus.

In some embodiments, a second fanout assembly 702b of the fanout assemblies 702a, 702b can be configured to operate as described above for the first fanout assembly 702a. In some embodiments, a second optical transceiver 704b of the optical transceivers 704a, 704b can be configured to operate as described above for the first optical transceiver 704a.

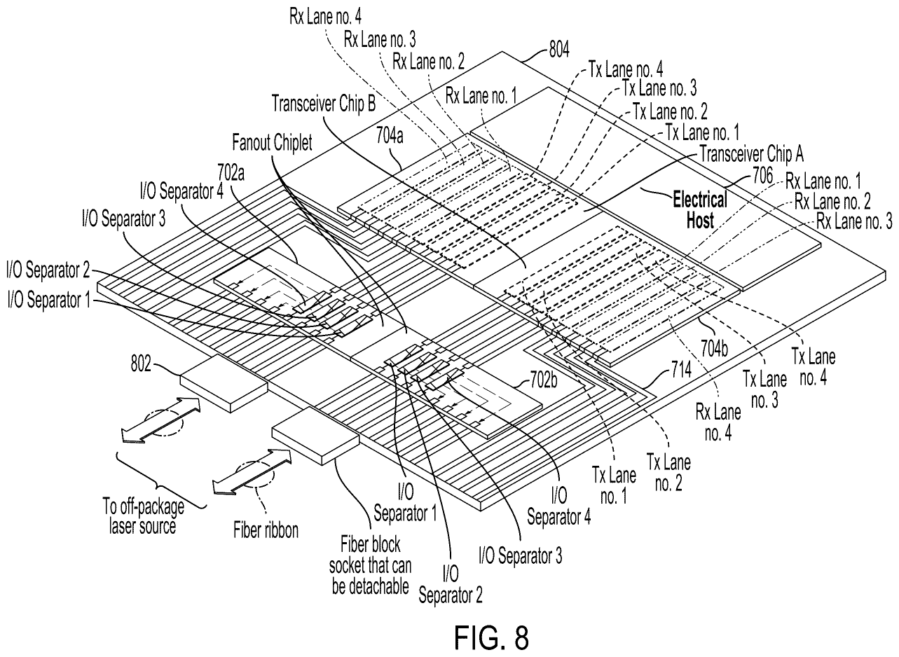

FIG. 8 is a schematic illustration of the example co-packaged implementation of FIG. 7 along with example fiber block sockets 802. As shown, the fiber block sockets 802 are coupled to a substrate 804 that co-packages the fanout assemblies 702a, 702b, the optical transceivers 704a, 704b, and the host 706. The fiber block sockets 802 can be detachable. The fiber block sockets 802 can be configured to be coupled to a fiber ribbon. The fiber ribbon may be coupled to off-package laser sources (e.g., pluggable laser sources).

Examples of the substrate 804 include ceramic, glass, polymer (e.g., one or more polymers), epoxy resin reinforced with fiberglass (e.g., FR-4), silicon or silicon compounds, and thin films. For example, the substrate 804 can be implemented by a printed circuit board (PCB). In another example, the substrate 804 can be implemented by glass.

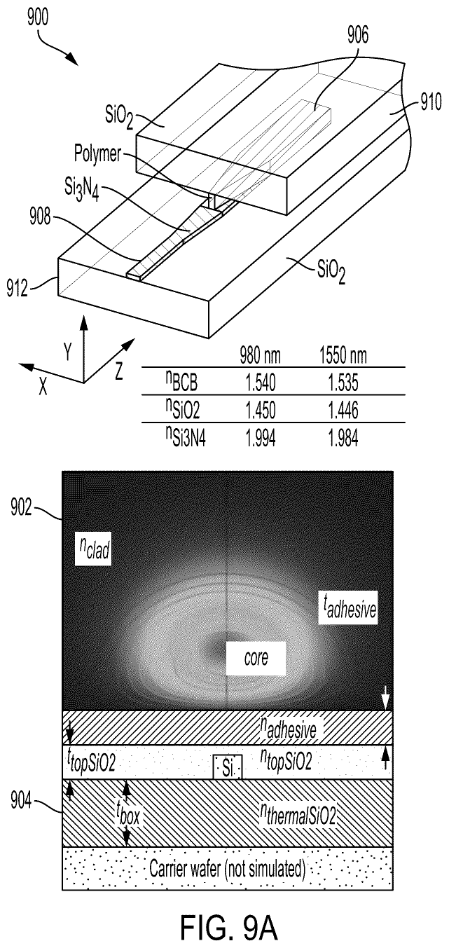

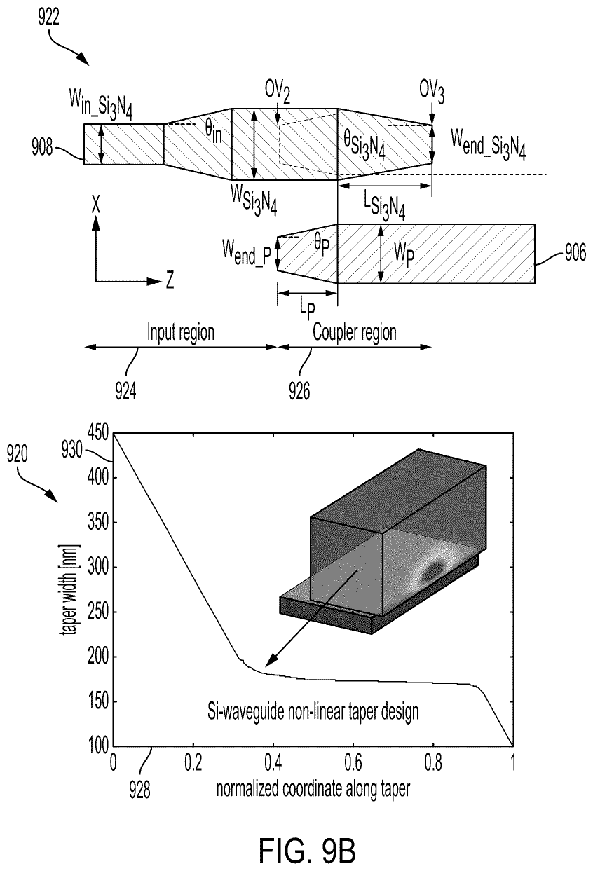

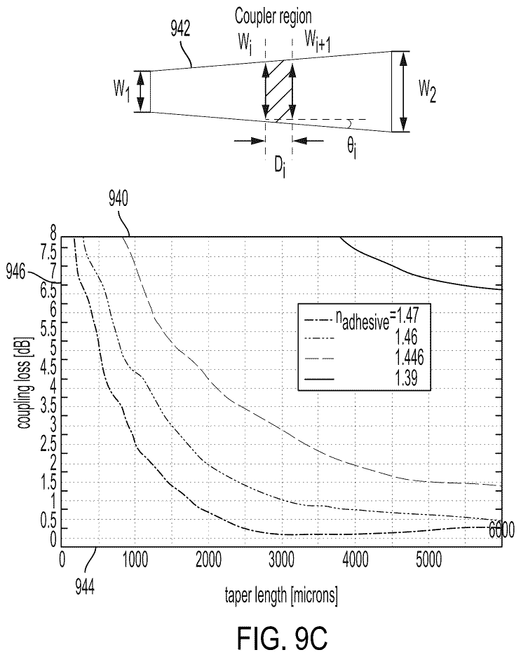

FIG. 9A depicts a perspective view of an ion-exchange (IOX) glass-silicon-waveguide stack 900, an image 902 of a simulation of the operation of the IOX glass-silicon-waveguide stack 900, and a cross-section view 904 of the IOX glass-silicon-waveguide stack 900. As shown, the IOX glass-silicon waveguide stack 900 includes a polymer 906 and an Si₃N₄ waveguide 908 disposed between first and second silicon dioxide (SiO₂) layers 910, 912.

In some embodiments, the co-packaged implementation of FIG. 8 can be implemented at least in part by the IOX glass-silicon waveguide stack 900. For example, the substrate 804 of FIG. 8 can be implemented by the SiO₂ layers 910, 912. In such an example, the optical connections 714 can be implemented by the polymer 906 and the Si3N4 waveguide 908. Example values for the refractive indices of the different layers are shown for different wavelengths.

FIG. 9B is a graph 920 representing analysis of a taper width design 922 optimized for low loss, short length coupler. In some embodiments, the taper width design 922 can implement the polymer 906 and the Si₃N₄ waveguide 908 of FIG. 9A.

As shown, a first end of the polymer 906 has a first width (or height) (identified by Wp) that tapers to a narrower, second width (or height) (identified by W_{end_P}) towards a second end, opposite the first end. Also shown, a first end of the Si₃N₄ waveguide 908 has a first width (or height) (identified by W_{in_Si3N4}) that increases to a second, wider width (or height) (identified by W_{Si3N4}) and then tapers to a narrower, third width (or height) (identified by W_{end_Si3N4}). In some embodiments, the first width and the third width are different while in other embodiments they are the same.

As shown, an input region 924 of the Si3N4 waveguide 908 may extend from the first end having the first width to a midportion having the second width. As shown, a coupler region 926 of the Si3N4 waveguide 908 may extend from the midportion to the second end having the third width. For example, the input region 924 can represent a portion of the Si3N4 waveguide 908 at which an optical signal may be input. In such an example, the coupler region 926 may represent a portion of the polymer 906 that optically couples to the input region 924 of the Si3N4 waveguide 908.

The graph 920 has an x-axis 928 representing a normalized coordinate along the taper of the taper width design 922 and a y-axis 930 representing a taper width in millimeters (mm). The graph 920 represents different taper width designs. As shown, an approximate normalized coordinate of 0.38 along the taper and a corresponding approximate taper width of 180 mm may yield an improved and/or otherwise optimized taper width design to achieve a low loss, short length coupler.

FIG. 9C shows a graph 940 representing coupling loss dependence on the taper length and adhesive refractive index for a coupler region design 942. In some embodiments, the coupler region design 942 can correspond and/or implement the coupler region 926 of FIG. 9B. As shown, the coupler region design 942 can have a first end having a first width (identified by w₁) that extends to a second end, opposite the first end, that has a wider, second width (identified by w₂).

The graph 940 has an x-axis 944 representing taper length measured in microns and a y-axis 946 representing coupling loss measured in decibels (dB). The graph 940 represents the coupling loss dependence on the taper length and adhesive refractive index (n_{adhesive}), which is computed for t_{adhesive}=1 micrometer. As shown, the coupling loss is reduced along the taper length for larger adhesive refractive indices.

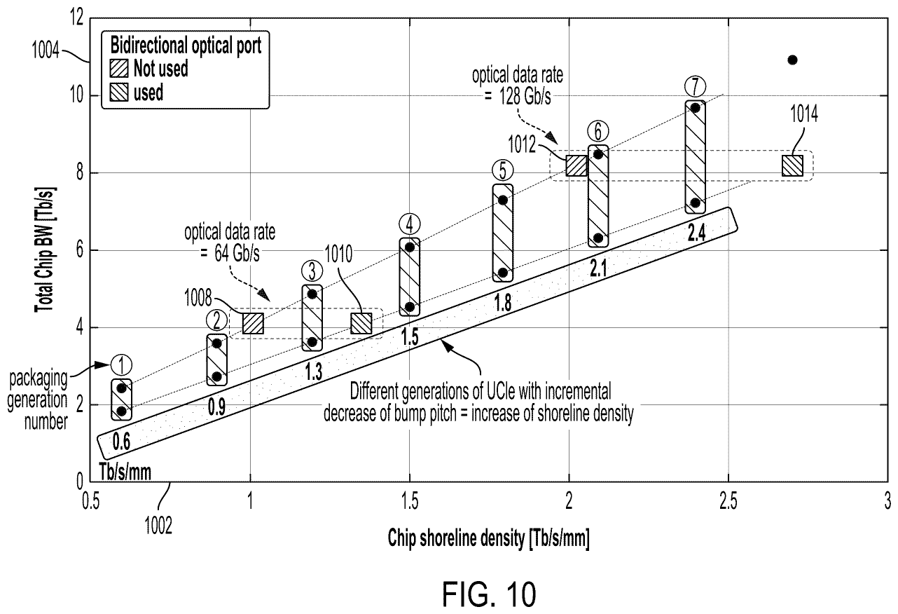

FIG. 10 is a graph 1000 representing improvements in chip shoreline density that can be achieved using some embodiments of the technology described herein. The graph 1000 has an x-axis 1002 of chip shoreline density measured in terabits per second per millimeter (Tb/s/mm) and a y-axis 1004 of total chip bandwidth measured in terabits per second (Tb/s). The graph 1000 may assume 8 lanes with 8 wavelengths per lane and an LD splitting ratio of 1:8 (e.g., a power split of 1:8 of the LD signals).

As identified by reference numeral 1008, conventional I/O interface units that do not use bidirectional optical ports as described herein can have a chip shoreline density of approximately 1 Tb/s/mm and a 4 Tb/s total chip bandwidth (BW) at an optical data rate of 64 gigabits per second (Gb/s). Beneficially, as identified by reference numeral 1010, I/O interface units configured and/or designed in accordance with some embodiments described herein that use bidirectional optical ports can have an increased chip shoreline density of approximately 1.4 Tb/s/mm with the same 4 Tb/s total chip BW at the same optical data rate of 64 Gb/s. For example, such I/O interface units configured and/or designed in accordance with some embodiments described herein that use bidirectional optical ports may correspond to and/or be implemented at least in part by the optical transceiver 200 of FIGS. 2A, 2B, 2C, 2D, the communication system 400 of FIGS. 4A-4B (or portion(s) thereof), etc.

Beneficially, the use of bidirectional optical ports as described herein can improve performance of existing generations of UCIe that is closer in performance to more advanced packaging generations. This benefit is also shown with respect to reference numerals 1012 and 1014 that illustrates that bidirectional optical port functionality can span multiple packaging generations.

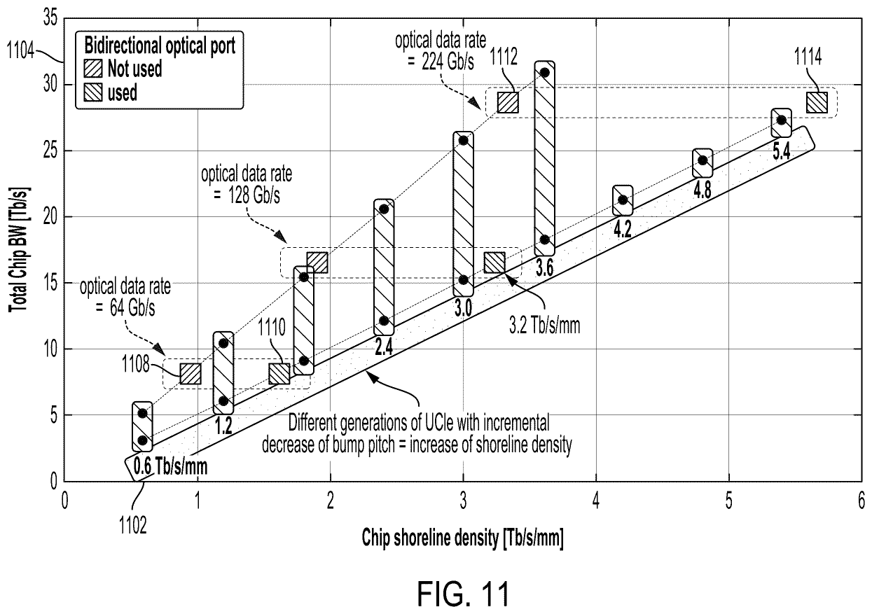

FIG. 11 is another graph 1100 representing improvements in chip shoreline density that can be achieved using some embodiments of the technology described herein.

The graph 1100 has an x-axis 1102 of chip shoreline density measured in Tb/s/mm and a y-axis 1104 of total chip bandwidth measured in Tb/s. The graph 1100 may assume 16 lanes with 8 wavelengths per lane and an LD splitting ratio of 1:8 (e.g., a power split of 1:8 of the LD signals).

As identified by reference numeral 1108, conventional I/O interface units that do not use bidirectional optical ports as described herein can have a chip shoreline density of approximately 1 Tb/s/mm and a 8 Tb/s total chip BW at an optical data rate of 64 Gb/s. Beneficially, as identified by reference numeral 1110, I/O interface units configured and/or designed in accordance with some embodiments described herein that use bidirectional optical ports can have an increased chip shoreline density of approximately 1.8 Tb/s/mm with the same 8 Tb/s total chip BW at the same optical data rate of 64 Gb/s. For example, such I/O interface units configured and/or designed in accordance with some embodiments described herein that use bidirectional optical ports may correspond to and/or be implemented at least in part by the optical transceiver 200 of FIGS. 2A, 2B, 2C, 2D, the communication system 400 of FIGS. 4A-4B (or portion(s) thereof), etc.

Beneficially, the use of bidirectional optical ports as described herein can improve performance of existing generations of UCIe that is closer in performance to more advanced packaging generations. This benefit is also shown with respect to reference numerals 1112 and 1114 that illustrates that bidirectional optical port functionality can span multiple packaging generations.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.” As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A,, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

1. An optical transceiver comprising:
a modulator configured to output a first modulated optical signal by modulating a first optical signal from a laser source;
a polarization rotator configured to output a second modulated optical signal by changing a first polarization state of the first modulated optical signal to a second polarization state; and
a polarization splitter comprising a bidirectional port, the polarization splitter configured to:
receive, by the bidirectional port, the first optical signal for output to the modulator; and
output, from the bidirectional port, the second modulated optical signal.

2. The optical transceiver of claim 1, wherein the first polarization state is a transverse electric (TE) polarization and the second polarization state is a transverse magnetic (TM) polarization.

3. The optical transceiver of claim 1, wherein the polarization splitter further comprises a first port and a second port, and wherein:
the first optical signal received by the bidirectional port has a transverse electric (TE) polarization,
the first optical signal is output from the second port with the TE polarization,
the second modulated optical signal is received by the second port and has a transverse magnetic (TM) polarization, and
the second modulated optical signal output from the bidirectional port has the TM polarization.

4. The optical transceiver of claim 1, further comprising an edge coupler coupled to the polarization splitter.

5. The optical transceiver of claim 4, wherein the edge coupler is configured to be coupled to a polarization circulator.

6. The optical transceiver of claim 1, further comprising a plurality of optical waveguides configured to respectively receive an optical signal representing data to be provided to a host coupled to the optical transceiver.

7. The optical transceiver of claim 1, further comprising an electrical interface configured to receive at least one electrical signal from a host, and the modulator is configured to modulate the first optical signal based on the at least one electrical signal.

8. The optical transceiver of claim 1, wherein the modulator comprises an optical splitter and a multiplexer, the optical splitter configured to split the first optical signal into at least a second optical signal to be provided to the multiplexer and a third optical signal, the multiplexer configured to output the second optical signal to the modulator.

9. The optical transceiver of claim 8, further comprising a second multiplexer, and the optical splitter is configured to output the third optical signal to the second multiplexer.

10. The optical transceiver of claim 1, wherein the optical transceiver comprises at least 8 receive ports and at least 8 transmit ports.

11. The optical transceiver of claim 1, wherein the optical transceiver comprises at least 16 receive ports and at least 16 transmit ports.

12. An apparatus comprising:
an optical transceiver comprising a first port configured as an optical transmit lane; and
a fanout assembly comprising a bidirectional port coupled to the first port of the optical transceiver, the bidirectional port configured to at least one of (i) output an optical signal from a laser source to the first port or (ii) receive a modulated optical signal from the first port.

13. The apparatus of claim 12, wherein the optical transceiver comprises a plurality of first ports configured as optical transmit lanes and a plurality of second ports configured as optical receive lanes, the plurality of first ports comprising the first port.

14. The apparatus of claim 12, wherein the fanout assembly comprises second ports, and wherein:
a first set of the second ports are configured to receive optical signals from laser sources, the optical signals comprising the optical signal, the laser sources comprising the laser source, and
a second set of the second ports are configured as optical transmit lanes, the optical transmit lanes comprising a first optical transmit lane configured to transmit the modulated optical signal from the first port.

15. The apparatus of claim 12, wherein the fanout assembly comprises:
a second port configured as an optical transmit lane; and
an optical circulator configured to at least one of (i) output the optical signal from the laser source to the bidirectional port or (ii) output, from the second port, the modulated optical signal received by the bidirectional port.

16. The apparatus of claim 12, wherein the fanout assembly comprises a chiplet.

17. The apparatus of claim 12, wherein the optical transceiver and the fanout assembly are co-packaged using a glass substrate or a polymer-based substrate.

18. A system comprising:
at least one laser source array comprising a plurality of laser sources;
at least one optical transceiver configured to convert optical signals from the plurality of laser sources into electrical signals as output to a host; and
at least one fanout assembly coupled to the at least one laser source array and the at least one optical transceiver, the at least one fanout assembly comprising at least one bidirectional port configured to at least one of (i) output one of the optical signals to the at least one optical transceiver or (ii) receive a modulated optical signal from the at least one optical transceiver.

19. The system of claim 18, further comprising a glass substrate comprising at least one of the at least one optical transceiver or the at least one fanout assembly.

20. The system of claim 18, further comprising a driver configured to control a modulation format of the modulated optical signal.
